(19) United States
(12) Patent Application Publication
(10) Pub. No.: US 2010/0303567 A1
(43) Pub. Date: Dec. 2, 2010

(54) Guide member for a hole saw

(76) Inventor: Nicolas M. Thomas, McKinney, TX (US)

Correspondence Address: WILSON DANIEL SWAYZE, JR., 3804 CLEARWATER CT., PLANO, TX, 75025, US

(21) Appl. No.: 12/476,955

(22) Filed: Jun. 2, 2009

(51) Int. Cl. B23B 51/04

(52) U.S. Cl. 408/1 BD; 408/200; 408/204

(57) ABSTRACT

The present invention may include a hole saw for use with a knockout of an electrical box, and the hole saw may include an arbor to clamp to a central shaft, a drive member to drive the hole saw, a saw blade connected to the drive member, a guide member to guide the saw blade. The guide member may be adapted to cooperate with the knockout of the electrical box and may rotate with respect to the central shaft. The central shaft may include a flat surface, and the arbor may include a set screw to cooperate with the flat surface. The guide member may include a cylindrical portion, and the guide member may include a narrow portion. The guide member may include a shoulder, and the saw blade may include a saw blade wall to connect to the drive member. The drive member may include a set screw, and a distal end of the central shaft may include a threaded portion. A fastening device may be connected to the threaded portion of the central shaft.

### FIELD OF THE INVENTION

This invention relates to a guide member for a hole saw to enlarge holes in an electrical box.

### BACKGROUND

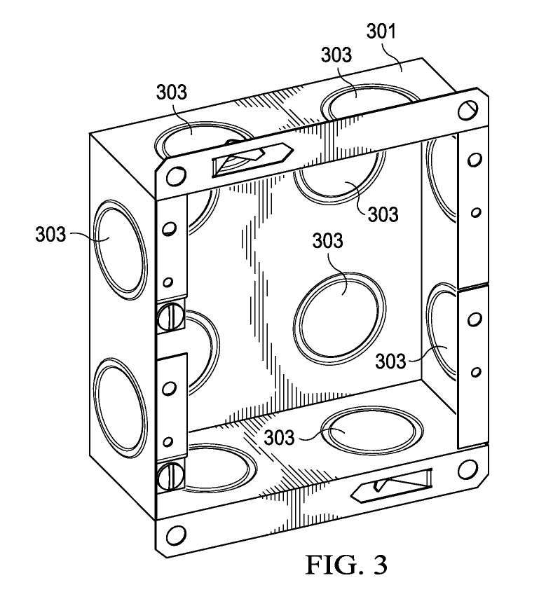

It is known that electrical junction switch or outlet boxes are used to provide an isolated raceway for connections between electrical wires so that if a spark should develop from the connection the spark will not spread outside of the electrical box. FIG. 3 illustrates an electrical box use for electrical connections. Typically, these boxes 301 have knockouts 303 which may include a weakened area so that the metal which forms the electrical box can be deformed and a hole can be formed in the surface of the electrical box without further affecting the integrity of the electrical box 301. In order to seal these holes, a conduit with a conduit connection may be applied to be able to pull wire in it. As result, the hole has been sealed. The electrical boxes 301 are usually pre-formed with a number of these knockouts and the knockouts may be of different sizes. Larger knockouts may be used to accommodate larger conduits for larger diameter wires and cables. Smaller diameter knockouts may be used for small conduits and wires. Generally, an assortment of larger and smaller knockouts may be provided in the electrical box. Typically, the number of small knockouts is greater than the number of large knockouts. In some instances, it is desirable to use a larger number of large knockouts that may be accommodated for. In these instances, it is necessary to increase the size of the knockout holes without the use of weakened areas. One way of accomplishing this is to use a hole saw. However, there is no guidance for the saw, and consequently, the hole saw may cut a hole that is not centered with respect to the knockout. This may result in an unsatisfactory result.

There are various hole saw blade types manufactured by different saw blade producers. Usually, each type of hole saw blade requires a particular arbor construction for mounting the saw blade on a drive mechanism. Some interchangeability between various saw blade types and their mounting arbors exists in order to reduce the amount of hole saw components.

One type of universal hole saw arbor is described in U.S. Pat. No. 3,647,310. Such an arbor reduces considerably the amount of hole saw and arbor components required for a hole saw tooling, and permits interchangeability between the components of various manufacturers.

U.S. Pat. No. 2,800,812 discloses a shell cutter assembly in which a cutting blade is welded to a hollow socket, which combination then is subsequently assembled to the bore of a machine by a plurality of mounting openings. A pilot drill is mounted by a threaded connection within a corresponding threaded bore formed on the cutting blade.

U.S. Pat. No. 3,550,229 shows various hole saw blades and arbor constructions, one of which has the cutting blade formed integrally with a solid tubular stem. Such a construction prevents the use of a pilot drill with the blade which is desirable for most hole saw cutting operations because of such a solid stem construction.

Still another type of known hole saw and arbor construction is shown in U.S. Pat. No. 3,648,508. This construction provides a separate end cap to which a cylindrical hole saw blade is mounted by a tapered drive fit, enabling low cost cylindrical hole saw blades to be used.

### SUMMARY

The present invention may include a hole saw for use with a knockout of an electrical box, and the hole saw may include an arbor to clamp to a central shaft, a saw blade connected to the arbor a guide member to guide the saw blade.

The guide member may be adapted to cooperate with the knockout of the electrical box and may rotate with respect to the central shaft.

The central shaft may include a flat surface, and the arbor may include a set screw to cooperate with the flat surface.

The guide member may include a cylindrical portion.

The drive member may include a set screw, and a distal end of the central shaft may include a threaded portion.

A fastening device may be connected to the threaded portion of the central shaft.

### BRIEF DESCRIPTION OF THE INVENTION

The invention may be understood by reference to the following description taken in conjunction with the accompanying drawings, in which, like reference numerals identify like elements, and in which:

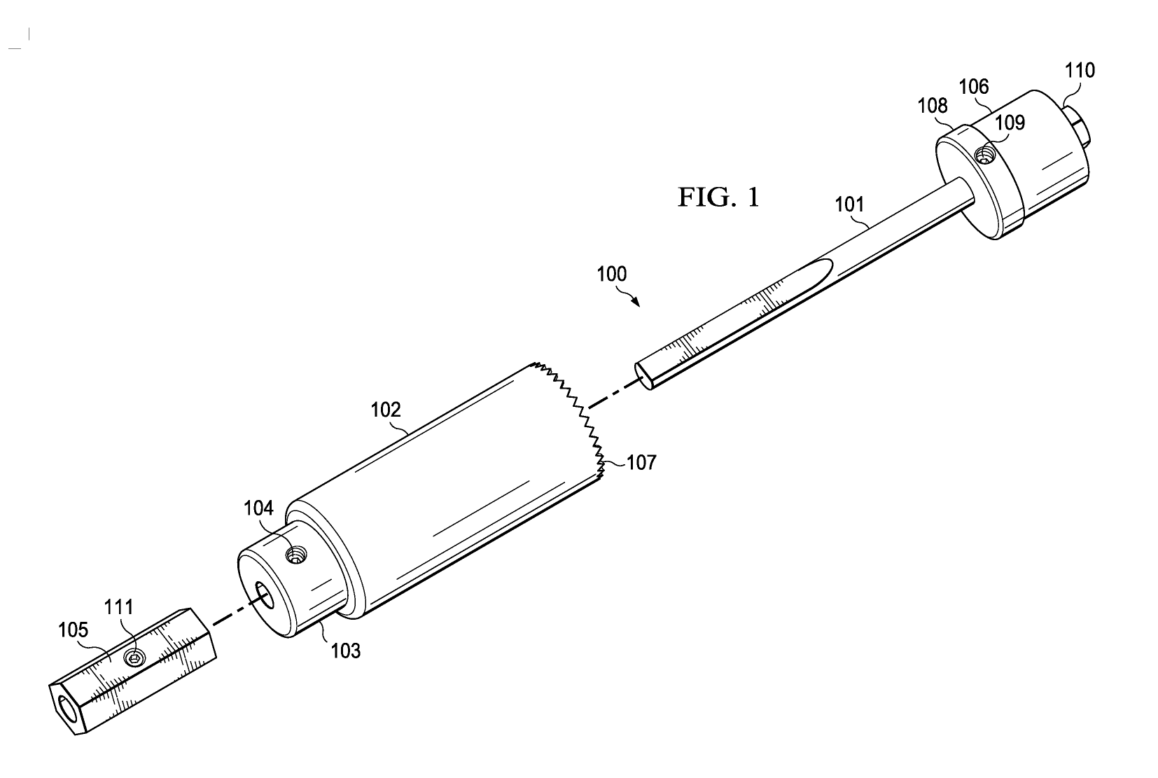

FIG. 1 illustrates a exploded view of the hole saw of the present invention;

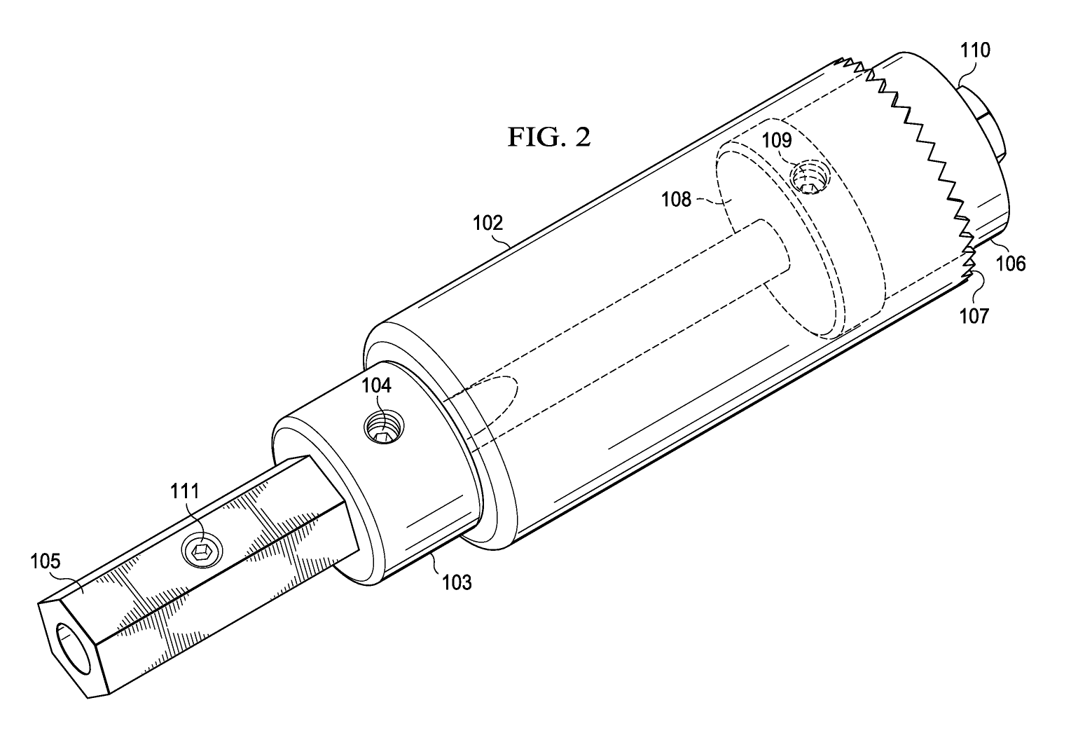

FIG. 2 illustrates a perspective view of the hole saw of the present invention;

FIG. 3 illustrates a perspective view of an electrical box;

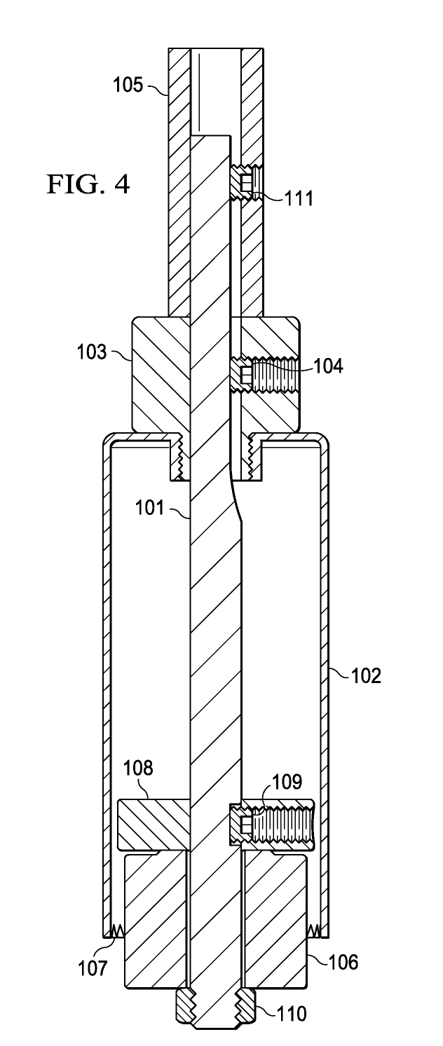

FIG. 4 illustrates a cross-sectional view of the hole saw of the present invention;

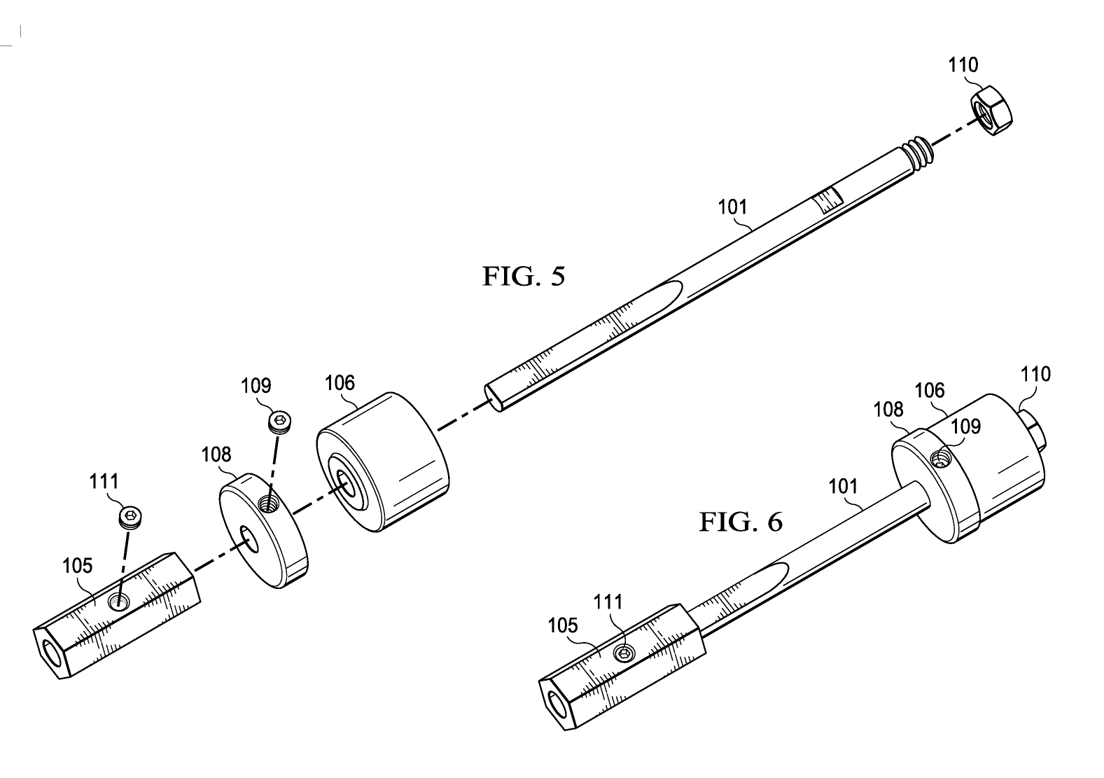

FIG. 5 illustrates an exploded view of the present invention;

FIG. 6 illustrates a perspective view of the present invention.

### DETAILED DESCRIPTION

FIG. 1 exploded view of the hole saw 100 of the present invention. The hole saw 100 may include a central shaft 101 which may connect to a hole saw arbor 103 which may extend from one end of the central shaft 101. One end of the central shaft 101 may connect to an adaptor 105 for the chuck which may be adapted to be placed in a portable drill (not shown) and to clamp the central shaft 101 to allow the hole saw blade 102 to cut a hole. The adaptor 105 for the chuck may include a set screw 111 to further clamp the central shaft 101.

The adaptor 105 for the chuck may have a hexagonal cross-section configuration which may include six longitudinal extending flat sides.

A guide member 106 may be rotatably connected to the central shaft 101 with a guide member retainer 110. A hole saw 102 may be connected to the hole saw arbor 103 by a threaded connection and may include hole saw teeth 107 in order to saw through the electrical box.

The hole saw 100 may include a guide member 106 which may be rotationally connected to the central shaft 101 and may be cylindrical. The guide member 106 may include a first guide member retainer 108 which may include a set screw 109 to clamp to the central shaft 101 and may include a central aperture to cooperate with the central shaft 101 so that the guide member 106 may rotate on the central shaft 101 The distal end of the central shaft 101 may include a threaded portion in order for a second guide member retainer 110 which may be a nut or other appropriate device to retain the guide member 106. The guide member 106 may have a diameter which cooperates with the diameter of the knockout 303 of the electrical box 301 (FIG. 3).

FIG. 2 illustrates a perspective view of the hole saw 100.

The hole saw 100 may include a central shaft 101 which may connect to a hole saw arbor 103 which may extend from one end of the central shaft 101. One end of the central shaft 101 may connect to an adaptor 105 for the chuck which may be adapted to be placed in a portable drill (not shown) and to clamp the central shaft 101 to allow the hole saw blade 102 to cut a hole.

The adaptor 105 for the chuck may include a set screw 111 to further clamp the central shaft 101.

The adaptor 105 for the chuck may have a hexagonal cross-section configuration which may include six longitudinal extending flat sides.

A guide member 106 may be rotatably connected to the central shaft 101 with a guide member retainer 110. A hole saw 102 may be connected to the hole saw arbor 103 and may include hole saw teeth 107 in order to saw through the electrical box.

The hole saw 100 may include a guide member 106 which may be rotationally connected to the central shaft 101. The guide member 106 may include a first guide member retainer 108 which may include a set screw 109 to clamp to the central shaft 101 and may include a central aperture to cooperate with the central shaft 101 so that the guide member 106 may rotate on the central shaft 101 The distal end of the central shaft 101 may include a threaded portion in order for a second guide member retainer 110 which may be a nut or other appropriate device to retain the guide member 106. The guide member 106 may have a diameter which cooperates with the diameter of the knockout 303 of the electrical box 301 (FIG. 3).

FIG. 4 illustrates a cross-sectional view of the hole saw 100.

The hole saw 100 may include a central shaft 101 which may include a flat surface and which may connect to a hole saw arbor 103 which may extend from one end of the central shaft 101. One end of the central shaft 101 may connect to an adaptor 105 for the chuck which may be adapted to be placed in a portable drill (not shown) and to clamp the central shaft 101 to allow the hole saw blade 102 to cut a hole. The adaptor 105 for the chuck may include a set screw 111 to further clamp the central shaft 101.

The adaptor 105 for the chuck may have a hexagonal cross-section configuration which may include six longitudinal extending flat sides.

A guide member 106 may be connected to the central shaft 101 with a guide member retainer 110. A hole saw 102 may be connected to the hole saw arbor 103 and may include hole saw teeth 107 in order to saw through the electrical box.

The hole saw 100 may include a guide member 106 which may be rotationally connected to the central shaft 101. The guide member 106 may include a first guide member retainer 108 which may include a set screw 109 to connect to the central shaft 101 and may include a central aperture to cooperate with the central shaft 101 so that the guide member 106 may rotate on the central shaft 101 The distal end of the central shaft 101 may include a threaded portion in order for a second guide member retainer 110 which may be a nut or other appropriate device to retain the guide member 106. The guide member 106 may have a diameter which cooperates with the diameter of the knockout 303 of the electrical box 301 (FIG. 3).

FIG. 5 illustrates the central shaft 101, the second guide member retainer 110, the guide member 106, the first guide member retainer 108, the adapter for chuck 105, the first guide member retainer set screw 109 and the chuck adapter set screw 111.

FIG. 6 illustrates the central shaft 101, the second guide member retainer 110, the guide member 106, the first guide member retainer 108, the adapter for chuck 105, the first guide member retainer set screw 109 and the chuck adapter set screw 111.

In operation, the user removes the knockout 303 from the outlet box 301. If a larger hole is desired that is not provided, then the user places the arbor 105 in the portable drill (not shown). The arbor 105 clamps the central shaft 101 by a set screw 111 cooperating with the flat surface of the central shaft 101. The portable drill rotates the arbor 105 and the central shaft 101. The central shaft 101 rotates the hole saw arbor 103 which rotates the saw blade 102. The guide member 106 is inserted into the knockout 303 and guides and centers the saw blade 102 as the saw blade 102 cuts a larger hole within the outlet box 301. As the saw blade 102 rotates, the guide member 106 may remain stationary with respect to the outlet box 301 in order to avoid damage to the outlet box 301.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1. A hole saw for use with a knockout of an electrical box, comprising;
an arbor to clamp to a central shaft;
a saw blade connected to the arbor;
a guide member to guide the saw blade;
wherein the guide member is adapted to cooperate with the knockout of the electrical box and rotates with respect to the central shaft.

2. A hole saw for use with a knockout of an electrical box as in claim 1, wherein the central shaft includes a flat surface.

3. A hole saw for use with a knockout of an electrical box as in claim 2, wherein the arbor includes a set screw to cooperate with the flat surface.

4. A hole saw for use with a knockout of an electrical box as in claim 1, wherein the guide member includes a cylindrical portion.

5. A hole saw for use with a knockout of an electrical box as in claim 1, wherein a distal end of the central shaft includes a threaded portion.

6. A hole saw for use with a knockout of an electrical box as in claim 1, wherein a guide member retainer is connected to the threaded portion of the central shaft.

7. A method for forming a hole saw for use with a knockout of an electrical box, comprising the steps of;
clamping an arbor to a central shaft;
connecting a saw blade to the arbor;
using a guide member to guide the saw blade;
wherein the guide member is adapted to cooperate with the knockout of the electrical box and rotates with respect to the central shaft.

7. A method for forming a hole saw for use with a knockout of an electrical box as in claim 6, wherein the central shaft includes a flat surface.

8. A method for forming a hole saw for use with a knockout of an electrical box as in claim 7, wherein the arbor includes a set screw to cooperate with the flat surface.

9. A method for forming a hole saw for use with a knockout of an electrical box as in claim 6, wherein the guide member includes a cylindrical portion.

10. A method for forming a hole saw for use with a knockout of an electrical box as in claim 6, wherein a distal end of the central shaft includes a threaded portion.

11. A method for forming a hole saw for use with a knockout of an electrical box as in claim 7, wherein a guide member retainer is connected to the threaded portion of the central shaft.
